(19) United States
(12) Patent Application Publication
(10) Pub. No.: US 2022/0105742 A1
(43) Pub. Date: Apr. 7, 2022

(54) Assembly Consisting Of A Two-Dimensional Network Of Micro-Optical Devices And A Network Of Micro-Images, Method For Manufacturing Same, And Security Document Comprising Same

(71) Applicant: OBERTHUR FIDUCIAIRE SAS, Paris (FR)

(72) Inventors: Marie Dejean, Cesson Sevigne (FR); Jean-Louis De Bougrenet De La Tocnaye, Guilers (FR); Vincent Nourrit, Brest (FR); Julien Gillot, Chateaugiron (FR); Xavier Borde, Osse (FR)

(73) Assignee: OBERTHUR FIDUCIAIRE SAS, Paris (FR)

(21) Appl. No.: 17/428,451

(22) PCT Filed: Feb. 5, 2020
(86) PCT No.: PCT/EP2020/052904

§ 371 Date: Aug. 4, 2021

(30) Foreign Application Priority Data
Feb. 7, 2019 (FR) 1901224

(51) Int. Cl. B42D 25/328; G02B 3/08; B42D 25/20; G02B 30/27

(52) U.S. Cl. CPC B42D 25/328; G02B 30/27; B42D 25/20; G02B 3/08

(57) ABSTRACT

The present invention particularly relates to an assembly (E) consisting of: a two-dimensional network of micro-optical devices such as microlenses; and a network of micro-images consisting, at most, of as many micro-images (ML) as micro-optical devices, each micro-image being subdivided into N image elements arranged in such a way as to reconstitute, for an observer and through the two-dimensional network of micro-optical devices, N images visble from N different points of view, i.e., N rendering angles, each of these N images representing a reference or recording point of view of a given relief scene consisting of at least one mobile object, characterised by the fact that the image elements consituting a given object within the N images are distriibuted within the network of micro-images in such a way that they appear, depending on the rendering angle, through different micro-optical devices, describing the trajectory of the projection of the object on the plane of the two-dimensional network of micro-optical devices relative to the reference point of view.

### FIELD OF THE INVENTION

The present invention relates to an assembly consisting of a two-dimensional network of micro-optical devices such as microlenses, and a network of micro-images consisting at most of as many micro-images as micro-optical devices. It also relates to a manufacturing method thereof and to a security document comprising the same.

### TECHNOLOGICAL BACKGROUND OF THE INVENTION

The invention described herein focuses on the motion of objects observable via a multi-stereoscopic viewing system.

Multi-stereoscopy was invented by G. Lippman in 1908 and developed by the photographer Mr. Bonnet. Under each microlens, pairs of image elements are positioned in the focal plane. Each image element forms one element (part) of an image. By means of the angle-selecting function of lenses, each of the images is therefore seen along a different direction. It is the observer's parallax movement which allows successive viewing of the different images.

Therefore, multi-stereoscopic devices are capable of generating motion of an object. In addition, binocularity can be employed in said devices to reconstruct a scene in relief by involving variations in binocular disparities. Numerous multiscopic devices have been described, in particular in the following patent documents: EP 3042238, EP2399159, U.S. Pat. No. 6,483,644 and EP2841284.

U.S. Pat. No. 6,046,848 teaches additional prior art.

An image display device is described therein integrated in a microlens system. This can be a «lenticular lens sheet» or a «fly's eye lens sheet».

Assuming that the network is a lenticular lens sheet, and that the lenticular structures are elongate in the horizontal direction, the images are formed in a plane and can move. But when the network is a lenticular lens sheet with vertical orientation of the lenticular structures, the images can appear in relief but are not animated. The possibility of combining motion and relief (for example with a two-dimensional network of «fly's eye lens sheet» type), is not at all mentioned.

DE 10 2016 109193 can also be cited, which provides for banknotes having micro-optical security elements.

It is the objective of the present invention to improve the devices described in the aforementioned documents, and more particularly to propose a device with which it is possible to obtain even more elaborate visual effects and in particular an impression of three-dimensional motion.

By so doing, it is possible not only to capture a user's/purchaser's interest even further but also to make unauthorized reproduction particularly difficult.

### SUMMARY OF THE INVENTION

Therefore, a first aspect of the invention relates to an assembly composed of:

a two-dimensional network of micro-optical devices such as microlenses;

and a network of micro-images consisting at most of as many micro-images as micro-optical devices,

each micro-image being sub-divided into N image elements arranged such that, for an observer and through said two-dimensional network of micro-optical devices, N images are reconstructed visible along N different points of view i.e. N angles of reconstruction corresponding to different positions of said observer, each of these N images representing a reference or recording point of view of one same scene in relief composed of at least two mobile objects,

characterized by the fact that the constituent image elements of one same object in said N images are distributed within said network of micro-images such that, depending on the angle of reconstruction, they appear through different micro-optical devices describing the trajectory of the projection of said object onto the plane of the two-dimensional network of micro-optical devices, in relation to the reference point of view,

so that, on parallax movement by an observer i.e. a change in angle of reconstruction, the first object of said two mobile objects appears in the plane of the two-dimensional network of micro-optical devices in monocular vision, and in volume in binocular vision, whilst moving in both cases in non-monotone fashion i.e. at non-constant velocity even when the parallax movement has constant angular velocity,

and so that the trajectory of the projection of the second mobile object onto the plane of the two-dimensional network of micro-optical devices, in relation to the reference point of view, has nonzero velocity on parallax movement by said observer, non-identical with the velocity associated with the projection trajectory of the first object, the relative movement in volume between these two objects being non-monotone i.e. the velocities of the two objects in volume are non-identical.

According to other nonlimiting, advantageous characteristics of this assembly:

said micro-optical devices are selected from among refractive lenses and Fresnel lenses;

said two-dimensional network of micro-optical devices is conformed in an orthogonal or hexagonal arrangement;

a first direction, called vertical direction, which extends along the plane in which said two-dimensional network is contained, is the direction in which the motion of said at least one mobile object is reconstructed, whilst a second direction called horizontal direction perpendicular to said first direction and in the plane in which said two-dimensional network is contained is the direction in which binocular vision is reconstructed;

said reference point of view is immobile when the scene is in movement, i.e. it is immobile in the vertical direction;

said two-dimensional network of micro-optical devices and said network of micro-images are carried by one same substrate;

said two-dimensional network of micro-optical devices and said network of micro-images are carried by different substrates;

the image reconstructed by combining the image elements of each subdivision, seen from at least one predetermined angle of observation, forms recognizable information or has a recognizable visual effect; and

said two-dimensional network of micro-images is generated by a display device such as a screen of a digital tool whether or not nomadic.

A further aspect of the invention relates to a method for manufacturing an assembly in accordance with one or other of the preceding characteristics. It is noteworthy in that it comprises the steps of:

recording said scene, in particular using computing means;

printing said image elements on a first surface of a substrate, to form said network of micro-images;

arranging said two-dimensional network of micro-optical devices on the surface of said substrate opposite said first surface;

said substrate being transparent and having a thickness equal to the focal distance of said micro-optical devices.

Finally, a last aspect of the invention relates to a security document such as a banknote, characterized by the fact that at least one of its opposite surfaces carries at least one two-dimensional network of micro-optical devices of the assembly in accordance with one of the aforementioned characteristics.

According to other nonlimiting and advantageous characteristics of this security document:

said two-dimensional network of micro-optical devices extends above a print carried by one of said opposite surfaces, this print forming the two-dimensional network of micro-images of said previously mentioned assembly;

said two-dimensional network of micro-optical devices extends through a window which opens onto said opposite surfaces and it comprises a print forming the two-dimensional network of micro-images of said previously mentioned assembly, this window and this print being arranged in relation to each other so that they can be superimposed at least momentarily;

said print is composed of at least one ink selected from the group composed of the following inks: visible ink that is black, coloured, matt, shiny, of iridescent effect, metallic, optically variable; invisible ink but visible under ultraviolet radiation (fluorescence or phosphorescence) or visible under infrared radiation;

said network of micro-optical devices is coated with a layer of transparent varnish so that the upper surface thereof is planar.

### BRIEF DESCRIPTION OF THE DRAWINGS

Other characteristics and advantages of the invention will become apparent on reading the following description of preferred embodiments of the invention. This description is given with reference to the appended drawings in which:

FIG. 1 is a schematic intended to illustrate the principle of multiscopy;

FIG. 2 is a schematic illustrating the fact that scenes in relief can be generated by multiscopy;

FIG. 3 is a schematic illustrating the fact that multiscopy allows the generating of motion in volume;

FIG. 4 is a first Figure intended to explain how images of a scene are recorded, conforming to the invention;

FIG. 5 is a second Figure intended to explain how images of a scene are recorded, conforming to the invention;

FIG. 6 is a third Figure intended to explain how images of a scene are recorded, conforming to the invention;

FIG. 7 is a first Figure intended to explain how previously recorded images are reconstructed through microlenses, conforming to the invention;

FIG. 8 is a second Figure intended to explain how previously recorded images are reconstructed through microlenses, conforming to the invention;

FIG. 9 is a third Figure intended to explain how previously recorded images are reproduced through microlenses, conforming to the invention;

FIG. 10 is a schematic illustrating projection onto a plane of an object in space;

FIG. 11 is a similar schematic to the preceding Figure, relating to two moving objects;

FIG. 12 is a first schematic illustrating the method of the invention;

FIG. 13 is a second schematic illustrating the method of the invention;

FIG. 14 is a third schematic illustrating the method of the invention;

FIG. 15 is a fourth schematic illustrating the method of the invention;

FIG. 16 is a fifth schematic illustrating the method of the invention;

FIG. 17 is a schematic showing a banknote from overhead, one of the surfaces thereof carrying an assembly of the present invention;

FIG. 18 is a very schematic cross-sectional view of the assembly in the preceding Figure;

FIG. 19 is a similar view to FIG. 18 of a first variant of embodiment;

FIG. 20 is a similar view to FIG. 18 of a second variant of embodiment;

FIG. 21 is a similar view to FIG. 17, the banknote being provided with a transparent window which only carries a lens network of said assembly, this Figure also showing a telephone with a screen on which a network of micro-images can be displayed;

FIG. 22 shows a banknote which, in a first region, comprises a transparent window only carrying a network of lenses of said assembly, and in a second region a print of a network of micro-images.

### DETAILED DESCRIPTION OF THE INVENTION

In the remainder of the description, including the drawings, similar references used to refer to different Figures designate same or similar elements.

In the entire present application, by the generic expression «mobile object», it is meant the representation of at least one entity of any kind such as an object, a person, a symbol etc. Evidently, the adjective «mobile» refers to motion of said object such as perceived by an observer when examining this object through an assembly of the invention via a parallax movement in relation to this assembly. Additionally, when it is indicated that an object has velocity it is evidently considered that it is nonzero velocity.

Also, «non-monotone» is used to qualify a velocity or motion at non-constant velocity (variable). If motion is relative motion between two mobile objects, the term «non-monotone» only means that they have different respective velocities, in other words the difference in velocity of the two mobile objects is nonzero. Preferably, this difference in velocity is variable.

### 1/ Multiscopy can Generate Motion of Objects

Focusing initially on the case of monocular vision, the observer changes point of view relative to the device by means of parallax movement. The observer therefore sees a succession of images and hence the possibility of reconstructing a movement.

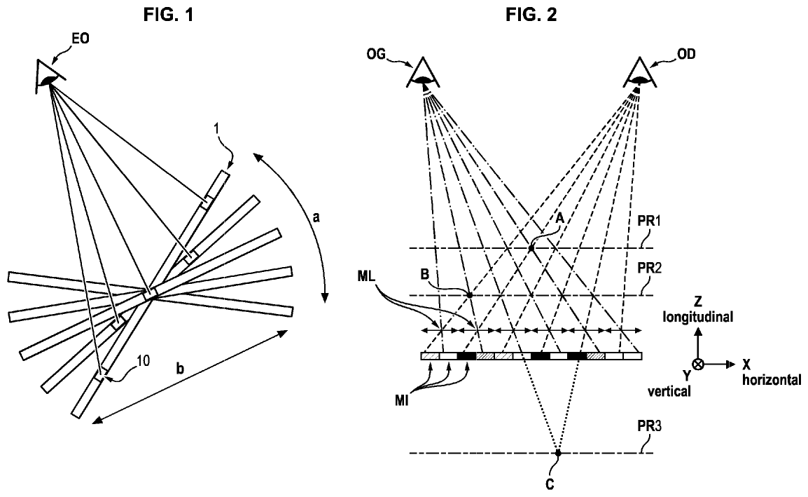

FIG. 1 illustrates said situation. On parallax movement, for the observer's eye EO, an object 10 carried by a multiscopic device 1 and substantiated here by a cross inside a square, appears at a different position in each image which creates a visual impression of motion. In this Figure, the double arrow “a” represents the assumed monotone movement (i.e. at constant velocity) of device 1 in relation to the observer, whilst the double arrow “b” illustrates motion of the object 10 in the device 1.

### 2/ Multiscopy can Generate Scenes in Relief

In the real world, an observer sees the device with both eyes.

Therefore, giving consideration now to binocular vision, the two eyes OG and OD of an observer being distant by the interpupillary distance IPD, they have differing points of view and hence they each perceive a different image. The brain merges these two images thereby creating a sensation of depth.

For example, in FIG. 2 six lenses ML are illustrated with a pair of image elements MI placed under each one. The left OG sees all the right-side image elements and the right eye OD sees all the left-side image elements. The final image seen by the observer is formed of three points A, B and C. These points are seen in different planes of relief PR1, PR2 and PR3 since the constituent image elements MI thereof are spaced differently.

It is evident that the direction connecting both eyes (here called the horizontal direction) allows greater binocular disparity than the vertical direction. In the present invention, priority is therefore given to this horizontal direction to create relief. Therefore, a change in image at the time of horizontal parallax movement will cause parallax motion to appear in the scene in relief.

### 3/ Multiscopy Can Generate Motion in Volume

It is of interest to use the two preceding results to create motion in volume. For this purpose, the effect due to binocularity is combined with the effect due to vertical parallax movement.

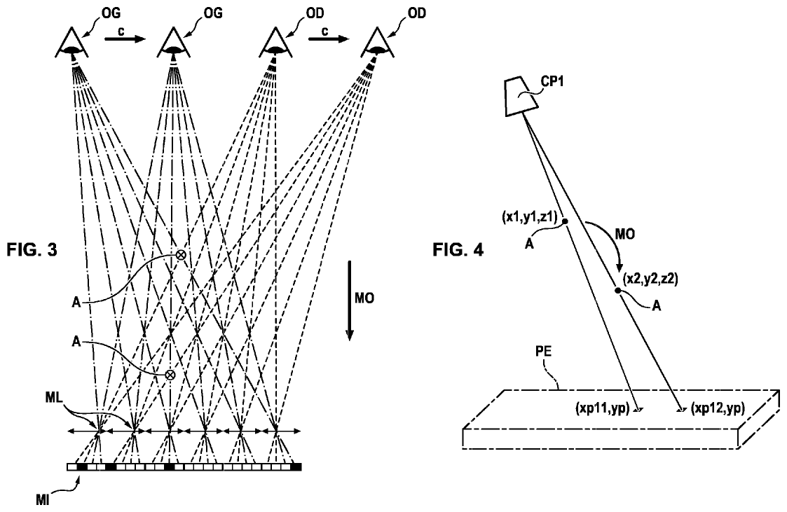

FIG. 3 illustrates the motion of object A perceived in relief resulting from the observer's parallax movement.

In this Figure, the arrows “c” represent the parallax movement of the right and left eyes OD and OG.

On account of the parallax movement and binocularity, object A appears to move away from the observer as symbolised by the arrow MO.

Since the horizontal direction is more suitable for the creation of relief, the vertical direction (and hence the observer's vertical parallax movement) is preferably dedicated to the trajectories of objects.

To determine the motion characteristics of an object in volume and for this motion to be described non-monotone fashion for a multi-stereoscope system, the relationship must be established between the object in space and its projection onto the plane of the device.

This is detailed below.

### 4/ Relationship between the Object in Space and its Projection onto the Plane of the Multiscopic Device

To simplify the equations used, the object is compared to a dot. Reproduction of motion in space with microlenses is possible by placing the projections of the object onto the plane of the microlenses. Consideration is therefore given to a dot in space having the trajectory described by the following equations:

$$( x ( t ) , y ( t ) , z ( t ) ) \qquad EQ1$$

The velocity of the object can be deduced:

$$( \dot{x} ( t ) , \dot{y} ( t ) , \dot{z} ( t ) ) \qquad EQ2$$

and the acceleration thereof:

$$( \ddot{x} ( t ) , \ddot{y} ( t ) , \ddot{z} ( t ) ) \qquad EQ3$$

### 4.1/ Recording in a Plane

A virtual point of view is also introduced (i.e. a reference point of view used to create the images) which moves as per the equations:

$$( X ( t ) , Y ( t ) , Z ( t ) ) \qquad EQ4$$

20

and allowing projection of the object to be obtained onto the plane of the device at each instant t:

$$( {x}_{p} ( t ) , {y}_{p} ( t ) ) \qquad EQ5$$

This is the recording step of the images. FIGS. 4 to 6 respectively relate to three examples of image recording.

In the first example in FIG. 4, the object A moves in space with motion MO whilst the reference point of view (camera CP1 is immobile at position 1). Projections of the images onto a recording plane PE respectively have the coordinates (xₚ11, yₚ) and (xₚ12, yₚ).

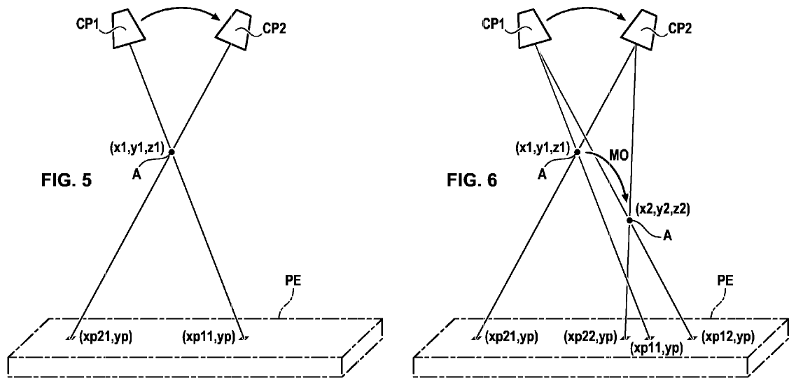

In the second example in FIG. 5, it is the reverse. Object A is immobile whereas the reference point of view is displaced (camera changing from position CP1 to CP2). The projections of the images onto the recording plane PE respectively have the coordinates (xp21, yp) an (xp11, yp).

Finally, the situation in FIG. 6 is a generalization of the preceding examples, wherein the object and the reference point of view move simultaneously. Evidently, these examples are particular cases where yₚ is constant.

### 4.2/ Reconstruction of Motion

Once recorded, the images are cut into image elements which are interwoven and placed under microlenses.

By the term “interwoven”, it is meant in the assembly of the present application that the image elements placed under one same lens are parts of images of one same scene, but resulting from different points of view.

All the image elements of one same image will occupy a very specific position under the microlenses so that they are all seen by an observer from the desired viewing angle (also called «reconstruction viewing angle»).

This reconstruction viewing angle is not necessarily related to the reference point of view since it is dependent on the position of the image elements under the lenses. In other words, the reference point of view is solely used for the construction of images.

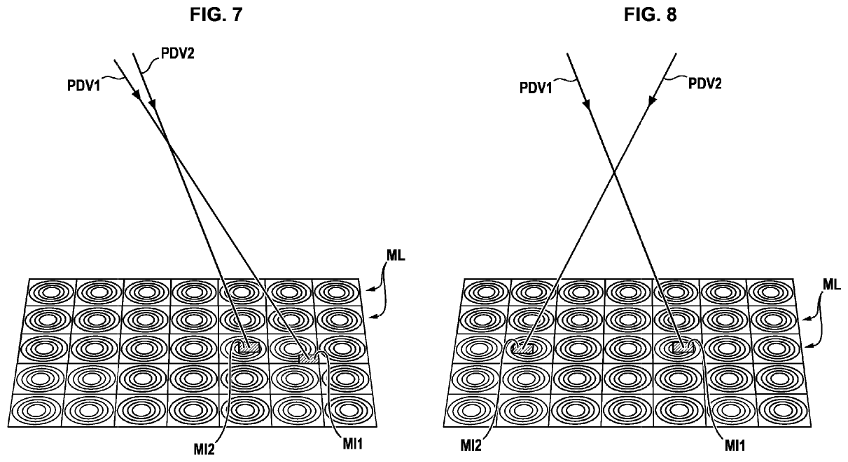

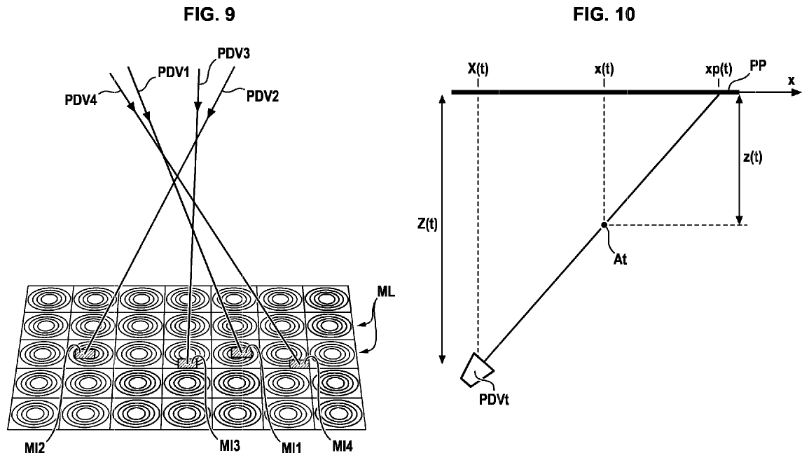

FIGS. 7 to 9 illustrate the possibility of reconstructing previously recorded images i.e. respectively corresponding to the situations in FIGS. 4 to 6 described above.

In these Figures, the references PDV with an associated number designate different, successive points of view whilst the references MI1 to MI4 designate the corresponding image elements integrated in the network of microlenses ML.

In the remainder hereof, consideration will only be given to the continuous case, which means that it is considered that the trajectories of the object in space and projection thereof onto the plane are continuous («paving», i.e. the arrangement of the lenses in relation to each other as well as their shape, size and limited number of image elements to be placed under each lens are not taken into account).

### 4.3/ Relationship between Object and Projection thereof

Under the aforementioned conditions (i.e. point object and continuous case) the motion equations of the projection of an object can be expressed as a function of equations of object motion in space and movement of a reference point of view.

These equations are obtained geometrically as shown in FIG. 10 where PDVₜ corresponds to the position of the point of view at time t, whilst Aₜ corresponds to the position of dot A at time t.

$$\{ \begin{matrix}{x}_{p} ( t ) \\ {y}_{p} ( t )\end{matrix} = \{ \begin{matrix}\frac{x ( t ) Z ( t ) - z ( t ) X ( t )}{Z ( t ) - z ( t )} \\ \frac{y ( t ) Z ( t ) - z ( t ) Y ( t )}{Z ( t ) - z ( t )}\end{matrix} \qquad EQ6$$

Equations where:

xₚ(t)and yₚ(t) respectively designate expression of the motion of object A projection along axes x and y;

X(t), Y(t) and Z(t) are coordinates of the point of view PDV at time t;

x(t), y(t) and z(t) are coordinates of the dot A at time t.

The velocity and acceleration in the plane of projection PP are easily deduced by derivation.

It was seen previously that motion occurs with a vertical parallax movement (downward head movement and reciprocally).

However, the apparent motion of object A could be disturbed by movement of the reference point of view creating ambiguity. To prevent any confusion, it is then assumed that the reference point of view is immobile when the object is in movement.

Conversely, for the effect of parallax movement, it is assumed that the object is immobile whilst the reference point of view is moved. This is why, in the remainder hereof, it is considered that the expressions of projections are solely functions (u and u′) of the coordinates of the object in space:

$$\{ \begin{matrix}{x}_{p} ( t ) = u ( x ( t ) , z ( t ) ) \\ {y}_{p} ( t ) = {u}^{′} ( y ( t ) , z ( t ) )\end{matrix} \qquad EQ7$$

### 5/ Conditions for Non-Monotone Motion

More specifically, it is sought to create non-monotone motion in the plane which also translates as non-monotone motion in space.

### 5.1/ For a Single Object

In the event that there is only one moving object, it is therefore desired that the norm of the projection velocity vector vₚ should be non-constant (condition c1) and that the norm of the velocity vector in space should also be non-constant (condition c2). These conditions can be written as follows.

There is at least one time t such that:

$$\begin{matrix}{v}_{p} = \sqrt{{\dot{x}}_{p}^{2} ( t ) + {\dot{y}}_{p}^{2} ( t )} \neq cte \\ i . e . & EQ8 \\ \frac{{dv}_{p}}{dt} \neq 0 ⇔ ( {\dot{x}}_{p} ( t ) {\ddot{x}}_{p} ( t ) + {\dot{y}}_{p} ( y ) {\ddot{y}}_{p} ( t ) ) \text{/} {v}_{p} \neq 0 & EQ 9\end{matrix}$$

The norm of projection velocity is necessarily nonzero (vₚ≠0), otherwise there would be no motion. Therefore, condition c1 is written:

$${\dot{x}}_{p} ( t ) {\ddot{x}}_{p} ( t ) + {\dot{y}}_{p} ( y ) {\ddot{y}}_{p} ( t ) \neq 0 \qquad EQ10$$

Similarly, when considering the norm of velocity in space, we should have:

$$v = \sqrt{{\dot{x}}^{2} ( t ) + {\dot{y}}^{2} ( t ) + {\dot{z}}^{2} ( t )} \neq cte \qquad EQ11$$

Consequently, the second condition c2 is written:

$$\frac{dv}{dt} \neq 0 ⇔ ( \dot{x} ( t ) \ddot{x} ( t ) + \dot{y} ( t ) \ddot{y} ( t ) + \dot{z} ( t ) \ddot{z} ( t ) ) \neq 0 \qquad EQ12$$

The two conditions can be coupled together since xₚ and yₚ are the result of the projection of the coordinate points (x,y,z).

Firstly, if there is solely access to motion of the object in space, and it is desired that this motion meets the conditions set forth above, these components must verify the following system of equations:

$$\{ \begin{matrix}\dot{x} ( t ) \ddot{x} ( t ) + \dot{y} ( t ) \ddot{y} ( t ) + \dot{z} ( t ) \ddot{z} ( t ) \neq 0 \\ \dot{u} ( x ( t ) , z ( t ) ) \ddot{u} ( x ( t ) , z ( t ) ) + {\dot{u}}^{′} ( y ( t ) , z ( t ) ) {\ddot{u}}^{′} ( y ( t ) , z ( t ) ) \neq 0\end{matrix} \qquad EQ13$$

Secondly, if there is solely access to motion in the plane of projection, the components of projection must verify the system:

$$\{ \begin{matrix}{\dot{x}}_{p} ( t ) {\ddot{x}}_{p} ( t ) + {\dot{y}}_{p} ( t ) {\ddot{y}}_{p} ( t ) \neq 0 \\ \dot{w} ( {x}_{p} ( t ) , z ( t ) ) \ddot{w} ( {x}_{p} ( t ) , z ( t ) ) + {\dot{w}}^{′} ( {y}_{p} ( t ) , \\ z ( t ) ) {\ddot{w}}^{′} ( {y}_{p} ( t ) , z ( t ) ) + \dot{z} ( t ) \ddot{z} ( t ) \neq 0\end{matrix} \qquad EQ14$$

with w and w′ two functions such that:

$$\{ \begin{matrix}x ( t ) = w ( {x}_{p} ( t ) , z ( t ) ) = {x}_{p} ( t ) \frac{Z - z ( t )}{Z} + z ( t ) \frac{X}{Z} \\ y ( t ) = {w}^{′} ( {y}_{p} ( t ) , z ( t ) ) = {y}_{p} ( t ) \frac{Z - z ( t )}{Z} + z ( t ) \frac{Y}{Z}\end{matrix} \qquad EQ15$$

It is noted that projection is a surjective function. This is why we still need to choose a function z(t) (longitudinal position of the object in space) so that it is possible to encode the desired motion directly in the plane.

### 5.2/ For at Least Two Objects

In addition, for non-monotone motion to be better perceived, a second object (or more) can be considered meeting the following conditions.

The projection velocities of the two objects must be different (condition c3) and their velocities in space must also be different (condition c4). These conditions translate as follows:

There is at least one time t such that c3:

$$\begin{matrix}{v}_{pA} \neq {v}_{pB} ⇔ \sqrt{{\dot{x}}_{pA}^{2} ( t ) + {\dot{y}}_{pA}^{2} ( t )} \neq \sqrt{{\dot{x}}_{pB}^{2} + {\dot{y}}_{pB}^{2} ( t )} \\ and c 4 \text{:} & EQ16 \\ {v}_{A} \neq {v}_{B} ⇔ \sqrt{{\dot{x}}_{A}^{2} ( t ) + {\dot{y}}_{A}^{2} ( t ) + {\dot{z}}_{A}^{2} ( t )} \neq \sqrt{{\dot{x}}_{B}^{2} ( t ) + {\dot{y}}_{B}^{2} ( t ) + {\dot{z}}_{B}^{2} ( t )} & EQ 17\end{matrix}$$

The two last conditions can be coupled together. Either by considering motion in space:

$$\{ \begin{matrix}{\dot{x}}_{A}^{2} ( t ) + {\dot{y}}_{A}^{2} ( t ) + {\dot{z}}_{A}^{2} ( t ) \neq {\dot{x}}_{B}^{2} ( t ) + {\dot{y}}_{B}^{2} ( t ) + {\dot{z}}_{B}^{2} ( t ) \\ \begin{matrix}{\dot{u}}^{2} ( {x}_{A} ( t ) , {z}_{A} ( t ) ) + {\dot{u}}^{′2} ( {y}_{A} ( t ) , {z}_{A} ( t ) ) \neq {\dot{u}}^{2} ( {x}_{B} ( t ) , \\ {z}_{B} ( t ) ) + {\dot{u}}^{′2} ( {y}_{B} ( t ) , {z}_{B} ( t ) )\end{matrix}\end{matrix} \qquad EQ18$$

or, by considering the motion of projection:

$$\{ \begin{matrix}{\dot{x}}_{pA}^{2} ( t ) + {\dot{y}}_{pA}^{2} ( t ) \neq {\dot{x}}_{pB}^{2} ( t ) + {\dot{y}}_{pB}^{2} ( t ) \\ {\dot{w}}^{2} ( {x}_{pA} ( t ) , {z}_{A} ( t ) ) + {\dot{w}}^{′2} ( {y}_{pA} ( t ) , {z}_{A} ( t ) ) + {\dot{z}}_{A}^{2} ( t ) \neq \\ {\dot{w}}^{2} ( {x}_{pB} ( t ) , {z}_{B} ( t ) ) + {\dot{w}}^{′2} ( {y}_{pB} ( t ) , {z}_{B} ( t ) ) + {\dot{z}}_{B}^{2} ( t )\end{matrix} \qquad EQ19$$

### 5.3/ Illustrations

It is now possible to illustrate a few cases in which the two conditions are verified or only one thereof. The fact that condition c1 (respectively c3) are met does not necessarily imply that condition c2 (respectively c4) are met, since projection is surjective.

Let us consider the following example: two different points in space (z_{A}≠z_{B}) having the same velocity:

$$( a = \frac{{l}_{t}}{Δ t} , 0 , 0 ) \qquad EQ20$$

and let us assume a static reference point of view for the reasons previously mentioned.

However, the projections thereof have different velocities:

$$\{ \begin{matrix}{\dot{x}}_{pA} ( t ) = \frac{aZ}{Z - {z}_{A}} \\ {\dot{y}}_{pA} ( t ) = 0 \end{matrix} \\ and \\ \{ \begin{matrix}{\dot{x}}_{pB} ( t ) = \frac{aZ}{Z - {z}_{B}} \\ {\dot{y}}_{pB} ( t ) = 0 \end{matrix} \qquad EQ21$$

The norms of their velocities are necessarily different since (z_{A}≠z_{B}). Therefore, only condition c3 is verified. This result can also be deduced geometrically.

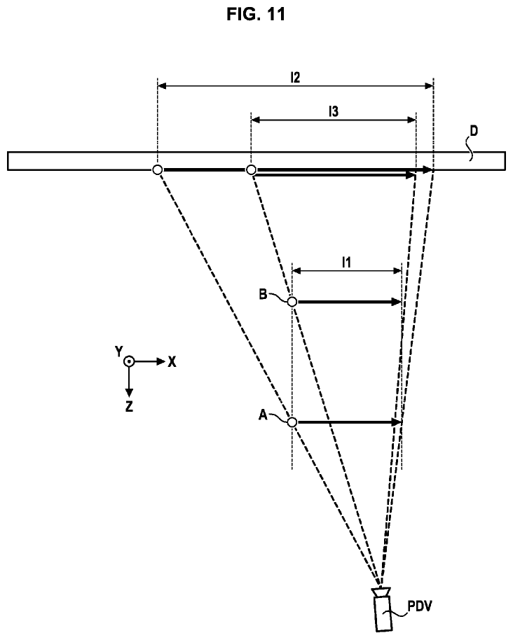

Considering FIG. 11 therefore, A and B are two objects in space and their trajectories travel the same distance l₁. For a time interval Δt, the norm of each of their velocities is equal to l₁/Δt. However, their trajectories in the plane of the device D (in relation to a reference point of view PDV) travel different distances: l₂>l₃.

As a result, their projection velocities also differ: l₂/Δt>l₃/Δt.

It is now easy to illustrate the case in which both conditions are verified with a similar example. Let us consider for example that dot B moves along distance l′₁<l₁ during the same time interval Δt. Therefore, \dot{x}_{A}(t)≠\dot{x}_{B}(t) (condition c4 is hence verified). Next, the projection of B moves along distance l′₃<l₃<l₂. And therefore, \dot{x}_{pA}(t)≠\dot{x}_{pB}(t) (condition c3 is hence verified).

Under these conditions, the preceding equation systems govern the conditions of any non-uniform motion of objects in a volume, by analysing their projections in the image-forming plane seen by the observer through a system of multi-stereoscopic type combining a matrix of image elements and a two-dimensional network of microlenses.

This multi-stereoscopy differs from conventional stereoscopy in that it has recourse to encoding in both directions (X and Y), and in that the sequencing of images irrespective of observer movement is able to generate objects having non-uniform relative motion, including a component with nonzero acceleration at least for one thereof.

As a result, the multi-stereoscopic system concerned here is composed of the association of a matrix of image elements combined with a two-dimensional network of microlenses (in theory and preferably periodic, of period p) enabling an observer to perceive the trajectory (sampled, having regard to the network pitch and limited number of image elements under each microlens) of objects moving within the visible volume (X,Y,Z), at a velocity that is strictly non-monotone. The elements of these trajectories are described by the projections of said motion onto a plane that can be compared to that of the plane of the microlense network (the focal plane containing the image elements and the plane of the microlenses can be considered to merge since the distance of observation is very long compared with the focal distance) via a set of variational equations explaining the formation conditions of said trajectories. If an object is compared to a point in space, the projection thereof is described by the equations EQ6 and must verify the equations EQ14. Its trajectory in space

$$\{ x ( t ) , y ( t ) , z ( t ) \}$$

must verify the equations EQ13.

In practice, these conditions will be generalized to volume objects and to discontinuous trajectories.

In the foregoing, so that the velocity differentials on the recorded trajectories are correctly translated at the time of reconstruction, the parallax movement needs to be uniform. However, in practice, parallax movement is not necessarily uniform. In the example of a single object which undergoes acceleration, there could therefore exist a parallax movement for which acceleration of the object is cancelled. But with at least two objects having different velocities, there is a guarantee at all events (irrespective of parallax movement) that the movements finally observed will not be uniform.

### 6/ Example of Embodiment of an Assembly of the Invention

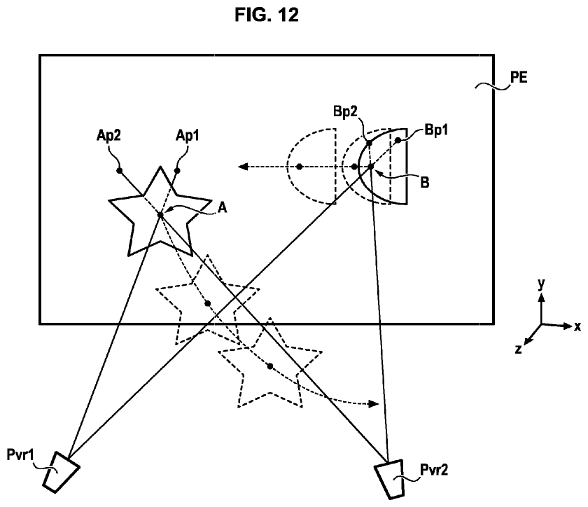

This example will be more particularly described in connection with FIGS. 12 to 16.

As illustrated in FIG. 12, the starting assumption is made that there are two objects, namely an object A which is the two-dimensional representation of a star, and an object B which is the two-dimensional representation of a quarter moon.

It is considered that the centres of these two objects (symbolised by points A and B) follow trajectories in space which verify the aforementioned equations EQ18. These trajectories are symbolised by the finely-dashed arrows.

Three instants of the moving scene are selected, namely t1, t2, and t3.

Only two reference points of view are considered (Pvr1 and Pvr2) which will allow capturing of the images.

For each time t1, t2 and t3, the two reference points of view Pvr1 and Pvr2 each record an image. These images correspond to the projections, onto the recording plane PE, of the objects moving in space along the aforementioned trajectories, the last two positions of the objects in space being shown in the Figure as dashed lines.

In the Figure, and for better clarity, only the projections of the centres of the objects are shown (Ap1, Ap2, Bp1, Bp2) and only at time t1. In reality, all the points of the objects are projected onto the plane at each time.

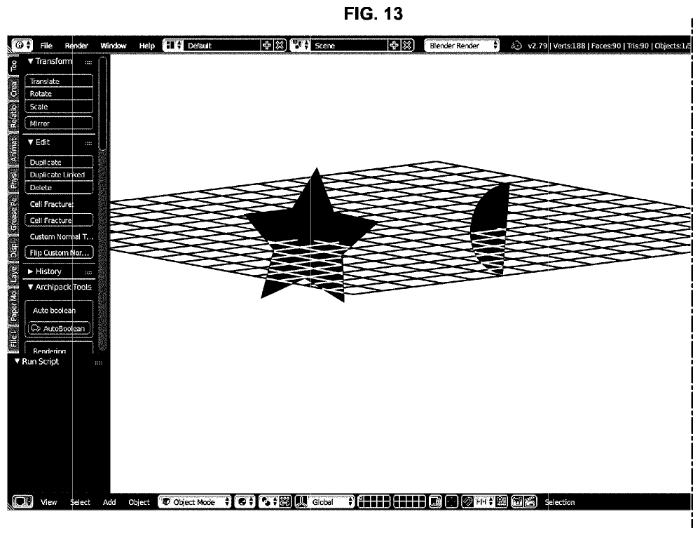

For this purpose, use can be made of software known under the trade name «BLENDER» (see screenshot in FIG. 13) with which it is possible «to record» images. It is also possible to create objects, to simulate their trajectories in space and to position the cameras which are to record the scene at different times.

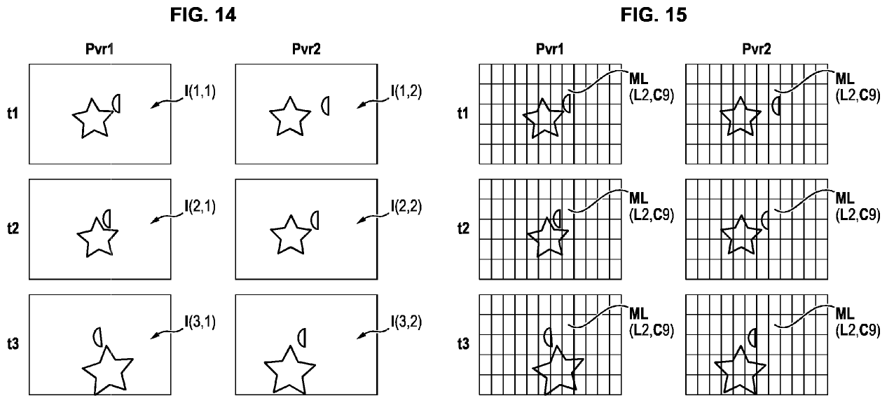

Overall, this gives six (3×2) recorded images as shown in FIG. 14. In this Figure, reference I(1,1) designates the image from the point of view Pvr1 recorded at time t1, and so on.

Considering for example that it is desired to make use of a network of microlenses ML formed of 60 lenses, arranged in five rows L1 to L5 and twelve columns C1 to C12 (see FIG. 15), the recorded images are assigned to the lenses concerned. Each assigned image i.e. addressed to a particular lens is then converted into a series of image elements, and these image elements are interwoven, which means that the image elements assigned to one same lens are placed one beside the other always following the same construction.

Therefore, considering FIG. 15 and assuming that attention is being given to lens ML(L2; C8) which belongs to row L2 and column C8 of the lens network, the six recorded images differ for times t1, t2 and t3, and for the points of view Pvr1 and Pvr2.

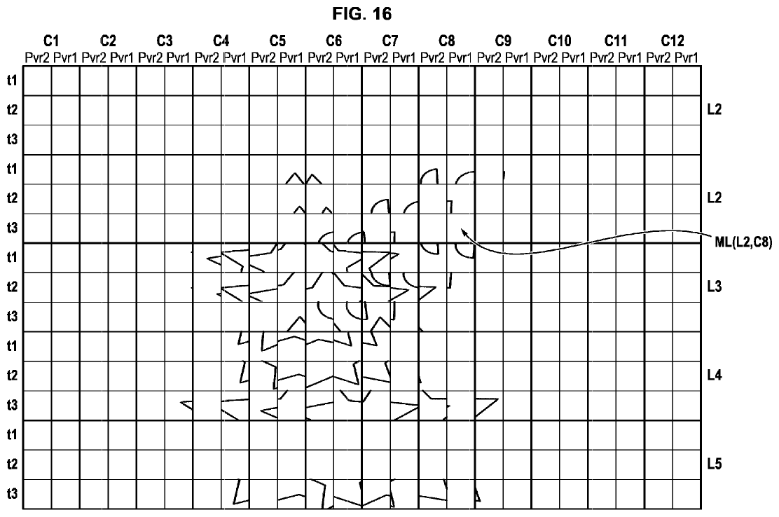

Turning our consideration to the grid in FIG. 16 and using the same lens, it is ascertained that six image elements corresponding to the aforementioned six images are arranged at the place of this lens, at relative positions corresponding to times t1 to t3, and to the two points of view.

The images are then printed and the lens manufactured.

Considering a substrate of thickness 36 μm (transparent film having a thickness equal to the focal distance of the lenses) and a micro-optical device of

Fresnel lens type of thickness between 1 and 4 μm, the image elements are then approximately 3 to 6 μm. If the thickness of the substrate is reduced, for example down to 12 μm, then image elements will be obtained of approximately 1 to 2 μm.

The targeted resolution for printing the images is then of the order of 25400 DPI (Dots per Inch). Yet standard printing methods of flexography, photogravure and offset type at most can reach a resolution of the order of 1270 DPI i.e. a line width of 20 μm.

It is therefore sought to use «micro printing» and for implementation thereof the following solutions can be envisaged to obtain a «master» containing the image:

For this step, an origination of a photosensitive resin is obtained via three-dimensional etching thereof with a view to obtaining a characteristic engraving of the image.

The origination can therefore be obtained in particular with the following techniques:

### a) Photolithography or Optical Lithography via Projection

Here a photosensitive resin is exposed to photons through a mask. In the exposed regions, the photons modify the solubility of the resin. If the resin is positive, the exposed region is removed on development, whereas if it is negative the exposed region is maintained on development;

### b) Greyscale Photolithography

In this particular case, the mask has grey shade levels, hence the densities of opaque pixels on a transparent background, the portions that are more or less exposed allowing management of different step heights;

### c) Laser Lithography

This technique is of interest since no mask is used. Lasers, such as UV, pulsed nanosecond, excimer, NdYAG, picosecond or femtosecond lasers are used directly on the resin. Resolution is in the region of 0.8 μm.

### d) Electronic Lithography Or E-Beam Lithography

This is a mask-free technique whereby patterns are created by direct scanning of an electron beam (10 to 100 electron volts) in the resin film. Resolution is equal to the diameter of the electron beam which represents a few nanometres. Etching depth is given by electron penetration which is 100 nm.

The point common to these technologies is that high resolution etching can be achieved (from a few nanometres to 0.8 μm).

Once this master of the image has been created, a recombining step is required to obtain a «multi-exposure print plate». For this step, the master is replicated (via thermal or UV-assisted embossing) on a plate of larger format comprising the number of desired images.

Next the cavities of the «print plate» are filled and excess ink is removed. This plate is then laid flat against the substrate and simultaneously dried for example using a UV dryer system. This allows congealing of the ink at the same it is transferred onto the substrate, thereby maintaining the definition of the image.

It is also possible to move the dryer into close proximity after transfer, for easier mechanical integration of the system. It must be positioned sufficiently nearby to prevent loss of resolution of the device.

It is also possible to position a dryer before transfer, to increase the viscosity of the ink and prevent flowing thereof before transfer onto the substrate.

This transfer technique can therefore be applied for one or more constituent colours of the micro-images.

The final image is placed under the lenses (at focal distance).

Finally, the assembly of the invention is affixed to a substrate such as a banknote.

Advantageously, the assembly E of the present invention is carried by a security document such as a banknote.

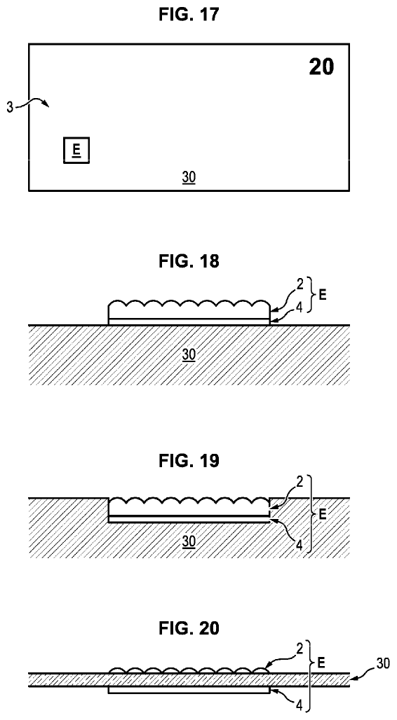

Said banknote 3 is very schematically illustrated in FIG. 17. On one 30 of its opposite surfaces, it carries said assembly E.

As shown more specifically by the embodiment in FIG. 18, the assembly E is here composed of a network 2 of lenses and a network of micro-images 4 carried by the surface 30 of the banknote.

In this case, the assembly E can be obtained in two steps, not necessarily consecutive, directly on the banknote substrate 3.

The assembly E can also be an add-on element which becomes joined to the banknote 3 after an application step (e.g. in the form of a hot or old transfer film, hot or cold rolled film, etc.) or an integrated element as illustrated in FIG. 19 with cross-sectional illustration of a security thread carrying the assembly E, the thread being inserted in the bulk of the substrate but with windows so that it can be seen exposed at some points on the surface from at least one of its sides.

Finally, as shown in FIG. 20, the assembly E can be an element passing through the substrate forming the banknote 3 (if it is formed for example of a transparent polymer opacified at some points except opposite the network 2).

Regarding the network of micro-images 4, this is therefore composed of the recognizable result of any technique to produce shapes, patterns, data for example in the form of images such as, but not limited thereto, printing, metallisation/demetallisation, laser etching or direct structuring of material to create so-called «structural» colours.

To mention only the printing technique, this can be carried out using any known method allowing the application of at least one ink selected from the group formed of the following inks: visible inks that are black, coloured, matt, shiny, with iridescent effect, metallic, optically variable; inks that are invisible but visible under ultraviolet radiation (fluorescence or phosphorescence) or visible under infrared radiation.

Also, the network of lenses 2 extends above the print, either permanently or momentarily.

This network of lenses can be etched for example at a first step in a photosensitive resin such as S1813 resin (supplied by Shipley) via photolithography.

Procedure can be as follows for origination thereof.

A layer of resin is deposited on a glass substrate. The resin-coated sheet is exposed to an ultraviolet laser beam that is modulated by a mask corresponding to the phase mask to be etched. After development, the mask regions that have been exposed are removed (if it is a “positive” resin, otherwise it is the non-exposed regions that are removed). The plate is therefore etched in relief, the maximum etch depth increasing with exposure time.

Starting with this origination, a replication process is initiated to obtain the tools and resulting end product i.e. the network of lenses 2 either directly on the banknote 3, or in a form that can be integrated therein (add-on part joined after application or integration) or in a form taking advantage of the transparency of the constituent substrate (as is the case with a banknote with polymeric substrate mentioned above).

Finally, there is also a variant in which this network of lenses 2 is removable and not joined to the banknote 3, and in this case solely the network 4 is permanently carried by the banknote.

Preferably, the non-planar upper surface of the network of lenses is coated with a transparent varnish to smooth the surface and prevent any fraudulent reproduction attempt via direct impression.

Once fabricated, the network is applied to the print previously prepared.

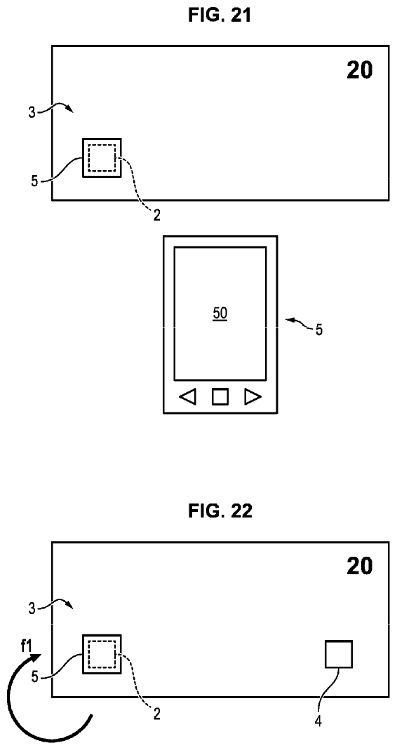

In the embodiment in FIG. 21, the banknote 3 comprises a window 5. This window is joined to the remainder of the banknote if the substrate is transparent (e.g. bi-oriented polypropylene banknote). If the substrate is opaque (e.g. cotton fibre-based banknote) this window is composed of an opening closed by a transparent polymer material, the latter housing the network of lenses 2.

With regard to the network of micro-images, this can be displayed on the screen 50 of a telephone 5 of “smartphone” type, or on the digital display screen of a digital device whether or not nomadic.

Therefore, by placing the window and the network displayed on the screen opposite each other, it is possible to verify the authenticity of the banknote depending on whether or not recognizable information is revealed, or a recognizable visual effect is highlighted.

Evidently, the above is to be considered only if the screen is in operation i.e. not switched off.

It is assumed that the network of micro-images, when displayed on the screen, is seen in the form of a fixed image (frozen).

The easiest methodology to cause motion of the images to appear through the network of lenses 2 is to vary the orientation of the banknote in relation to the screen (which remains fixed). But it is possible to carry out the reverse i.e. to vary the orientation of the screen in relation to the banknote (which remains fixed). In addition, it is possible only to use parallax movement (relative movement between the screen+banknote assembly and the observer) as in the case when microlenses and micro-images are carried by the same substrate.

A last alternative is successively to display different images on the screen which correspond to different points of view, which means that both the banknote and this screen can remain immobile in relation to each other and immobile in relation to the observer.

In the embodiment in FIG. 22, the networks 2 and 4 are arranged in two different regions of the banknote 3, so that by folding this banknote as shown by the arrow f1, it is possible to superimpose both networks to reveal information or a recognizable visual effect.

In one non-illustrated embodiment, the banknote could be one such as illustrated in FIG. 21 in which the window, in addition to the network of lenses, only carries a portion (e.g. one half) of the network of micro-images, whilst the matching portion is displayed on the screen of a telephone or other device.

In a final non-illustrated embodiment, the banknote 3 could only carry the network of micro-images 4, and the network of lenses 2 could be constructed on a removable substrate and added momentarily solely for the needs of authentication.

It is to be noted that the reference or recording points of view are advantageously chosen so that they have a regular pitch. However, provision could be made for a non-regular pitch to create non-uniformity in parallax movement.

1. An assembly composed of: a two-dimensional network of micro-optical devices such as microlenses; and a network of micro-images consisting at most of as many micro-images as micro-optical devices, each micro-image being sub-divided into N image elements arranged such that, for an observer and through said two-dimensional network of micro-optical devices, N images are reconstructed visible from N different points of view i.e. N angles of reconstruction corresponding to different positions of said observer, each of these N images representing a reference or recording point of view of one same scene in relief composed of at least two mobile objects,
wherein the constituent image elements of one same object in said N images are distributed within said network of micro-images such that, depending on the angle of reconstruction, they appear through different micro-optical devices describing the trajectory of the projection of said object onto the plane of the two-dimensional network of micro-optical devices in relation to the reference point of view, so that on parallax movement by an observer i.e. a change in angle of reconstruction, the first object (10; A; B) of said two mobile objects appears in the plane of the two-dimensional network of micro-optical devices in monocular vision, and in volume in binocular vision whilst moving in both cases in non-monotone fashion i.e. at non-constant velocity even when the parallax movement has constant angular velocity,
and so that the trajectory of the projection of the second mobile object onto the plane of the two-dimensional network of micro-optical devices, in relation to the reference point of view, has nonzero velocity on parallax movement by said observer, non-identical with the velocity associated with the projection trajectory of the first object, the relative movement in volume between these two objects being non-monotone i.e. the velocities of the two objects in volume are non-identical.

2. The assembly according to claim 1, wherein said micro-optical devices are selected from among refractive lenses and Fresnel lenses.

3. The assembly according to claim 1, wherein said two-dimensional network of micro-optical devices is conformed in an orthogonal or hexagonal arrangement.

4. The assembly according to claim 1, wherein a first direction, called vertical direction, which extends along the plane in which said two-dimensional network is contained, is the direction in which the motion of said at least one mobile object (10; A; B) is reconstructed, whilst a second direction called horizontal direction perpendicular to said first direction and in the plane in which said two-dimensional network is contained is the direction in which binocular vision is reconstructed.

5. The assembly according to claim 1, wherein the reference or recording points of view are chosen so that either they have a regular pitch or a non-regular pitch to create non-uniformity in parallax movement.

6. The assembly according to claim 1, wherein said reference point of view is immobile when the scene is in movement i.e. it is immobile in the vertical direction.

7. The assembly according to claim 1, wherein said two-dimensional network of micro-optical devices and said network of micro-images are carried by one same substrate or by different substrates.

8. The assembly according to claim 1, wherein the image reconstructed by combining the image elements of each subdivision, seen from at least one predetermined angle of observation, forms recognizable information or has a recognizable visual effect.

9. The assembly according to claim 8, wherein said two-dimensional network of micro-images is generated by a display device such as a screen of a digital tool whether or not nomadic.

10. A method for manufacturing an assembly according to claim 1, wherein it comprises the steps of:
recording said scene, in particular using computing means;
printing said image elements on a first surface of a substrate, to form said network of micro-images; arranging said two-dimensional network of micro-optical devices on the surface of said substrate opposite said first surface;
said substrate being transparent and having a thickness equal to the focal distance of said micro-optical devices.

11. A security document such as a banknote, wherein at least one of its opposite surfaces carries at least one two-dimensional network of micro-optical devices of the assembly according to claim 1.

12. The document according to claim 11, wherein said two-dimensional network of micro-optical devices extends above a print carried by one of said opposite surfaces, this print forming the two-dimensional network of micro-images of said assembly according to claim 1.

13. The document according to claim 11, wherein said two-dimensional network of micro-optical devices extends through a window which opens onto said opposite surfaces and it comprises a print forming the two-dimensional network of micro-images of said assembly according to claim 1, this window and this print being arranged in relation to each other so that they can be superimposed at least momentarily.

14. The document according to claim 11, wherein said print is composed of at least one ink selected from the group composed of the following inks: visible ink that is black, coloured, matt, shiny, of iridescent effect, metallic, optically variable; invisible ink but visible under ultraviolet radiation (fluorescence or phosphorescence) or visible under infrared radiation.

15. The document according to claim 11, wherein said network of micro-optical devices is coated with a layer of transparent varnish so that the upper surface thereof is planar.
